(19) United States
(12) Patent Application Publication
(10) Pub. No.: US 2024/0238632 A1
(43) Pub. Date: Jul. 18, 2024

(54) COMPACT SPRINKLER

(71) Applicant: Victaulic Company, Easton, PA (US)

(72) Inventors: Stephen Henry PECHACEK, Bangor, PA (US); Robert BALLARD, Whitehall, PA (US); Mitchell BROWN, Saylorsburg, PA (US); Craig HANEY, Nazareth, PA (US)

(21) Appl. No.: 18/411,075

(22) Filed: Jan. 12, 2024

Related U.S. Application Data
(60) Provisional application No. 63/543,526, filed on Oct. 11, 2023.
(60) Provisional application No. 63/438,870, filed on Jan. 13, 2023.

(51) Int. Cl. A62C 35/68; A62C 3/00; A62C 37/12

(52) U.S. Cl. CPC A62C 35/68; A62C 3/002; A62C 37/12

(57) ABSTRACT

A sprinkler includes an axially extending, generally tubular sprinkler frame having an inlet located at a proximal end and extending toward a distal end. A plurality of pins are anchored to the sprinkler frame and extending distally. A fluid deflector is oriented in a first position in a non-operative configuration of the sprinkler and distally slidable along the pins into a second position in an operative configuration of the sprinkler. A thermal trigger is supported by the sprinkler frame in the non-operative configuration of the sprinkler at an axial position distal to the deflector. The sprinkler frame is configured to mount to a fire protection piping network.

### CROSS-REFERENCE TO RELATED APPLICATION

This application claims priority from U.S. Provisional Patent Application No. 63/438,870, filed Jan. 13, 2023, titled “Storage Occupancy Sprinkler Head”, and from U.S. Provisional Patent Application No. 63/543,526, filed Oct. 11, 2023, titled “Storage Occupancy Sprinkler Head”, the entire contents of each of which are incorporated by reference herein.

### BACKGROUND OF THE DISCLOSURE

The disclosure generally relates to sprinklers, and, more particularly, to compact sprinklers, including those for use in storage occupancies.

Fire sprinkler systems are generally subject to approval of the local supervising authority, commonly referred to as the Authority Having Jurisdiction (AHJ), to ensure that the system complies with the relevant codes and other requirements. In turn AHJ's may rely on various national and internationally recognized standards, such as NFPA 13: Standard for the Installation of Sprinkler Systems (2022), which provides certain requirements for the design and installation of fire sprinkler systems relative to the commodity, the occupancy, and the manner in which protection is provided, including the type of sprinkler and various characteristics of the sprinkler. Similarly, FM promulgates Global Loss Prevention Data Sheets which also address the design and installation of fire sprinkler systems in consideration of the above factors. Additionally, AHJ's may rely on what are known as “listings”, provided by nationally recognized testing laboratories (or listing agencies) that promulgate performance-based standards for fire protection equipment which demonstrate that such equipment, including fire sprinklers, is suitable for providing fire protection when used in accordance with that laboratory's listing and installation codes such as NFPA 13 or FM Data Sheets. Industry-accepted laboratories that provide such listing services include UL, LLC (formerly known as Underwriter's Laboratories), and FM Approvals, LLC.

These standards and listings consider various characteristics of the sprinkler itself, which include, among other characteristics, the sprinkler discharge coefficient or nominal K-factor, the installation orientation (be it pendent, upright, or sidewall), the installation location (either ceiling, wall, or in the racks of storage occupancies), and the sprinkler thermal sensitivity or response time index (RTI) of the sprinkler, the sprinkler spacing, the pressure required to be applied to the sprinkler, and the sprinkler coverage area. The discharge coefficient, or K-Factor, is determined by the geometry of the sprinkler inlet and orifice size and is measured in units of GPM/psi^{1/2}, representing the fluid flow of the sprinkler relative to the system pressure. Higher K-factor sprinklers tend to flow more water to address higher-challenge fires or more challenging sprinkler installations. The thermally responsive trigger that reacts to heat from the fire event is typically rated in terms of both the nominal temperature of activation, such as, for example, between approximately 125° F. and approximately 300° F., and the RTI, which is a measure of the thermal sensitivity of the thermal trigger in units of (m·s)^{1/2}. Under the FM 2000 standard, a sprinkler with an RTI from 80 (m·s)^{1/2} to 350 (m·s)^{1/2} is defined as a “Standard Response” sprinkler and a sprinkler having an RTI equal to or less than 50 (m·s)^{1/2} is defined as a “Quick Response” sprinkler. In addition to such characteristics, laboratories may also prescribe water distribution testing and live fire testing in order to evaluate sprinkler performance and provide listing services.

In particular, to be considered “standard spray sprinklers” as defined, for instance, in NFPA 13, listing agencies may require distribution and fire testing. In UL's standard UL 199, this testing includes 10 and 16 pan distribution tests as well as a 350 pound wood crib fire test. Similarly, FM's FM2000 standard requires distribution testing and a 350 pound crib fire test to be performed.

Traditional storage occupancy sprinkler systems generally include ceiling mounted systems, in-rack systems, or a combination of both ceiling mounted and in-rack systems. Storage facilities commonly have ceiling heights of 20 ft or higher. With the onset of improved automated storage and retrieval systems that can retrieve items from greater heights, storage occupancy ceiling heights have dramatically increased, however, e.g., such as up to and in excess of 100 ft.

Storage sprinklers are generally defined to be those sprinklers which are listed and approved by nationally recognized laboratories for protecting storage occupancies. Such sprinklers generally have a k-factor of at least 11.2 and commonly include Early Suppression Fast Response (“ESFR”) sprinklers, Control Mode Specific Application (“CMSA”) sprinklers, Control Mode Density Area (“CMDA”) sprinklers, among others. To be listed as a CMDA sprinkler, both UL199 and FM2000 require specialized large scale fire tests.

As used herein, a sprinkler is said to be “qualified” for a particular recognized classification of sprinkler, such as a standard spray sprinkler, intermediate or in-rack sprinkler, or storage sprinkler if it has satisfied appropriate water distribution testing, live fire testing, and/or has been listed by an appropriate testing agency as having met the performance requirements of that recognized classification of sprinkler.

Where a ceiling only storage occupancy sprinkler system is employed, and as ceiling heights increase, the storage sprinklers employed in these facilities have had a concomitant increase in orifice size and, consequently, fire suppression fluid flow. Ceiling only storage sprinkler systems may be sized to support up to as many as 12, or in some instances 9, sprinklers activating simultaneously, and with nominal K-Factors commonly up to K25.2, and even K28 and K34, permitting exorbitant fire suppression fluid flows. Such extensive fire suppression fluid flow is required so that the fire suppression fluid may penetrate down to the source of the fire from the location of the sprinklers near the ceiling, which distance grows as ceiling heights increase. Moreover, for the fire to reach and activate the sprinklers, potentially from a low rack, the fire has to grow significantly, often beyond the ability of a single sprinkler, or a few sprinklers, to extinguish, resulting in a larger fire, more risk to firefighters, greater commodity loss through fire/smoke damage and fire suppression fluid damage.

With the onset of higher ceiling storage facilities, overhead ceiling mounted sprinkler systems are becoming inefficient and incorporating in-rack systems, mounted directly within the storage racks, is becoming particularly significant. In-rack systems, however, do not employ purpose-specific sprinklers having a spray pattern specifically designed to effectively and efficiently disperse fire suppression fluid throughout the storage racks. Rather, current in-rack sprinkler systems employ sprinklers designed for other purposes, such as standard commercial sprinklers, including sprinklers qualified as standard spray sprinklers, or ESFR sprinklers.

Another drawback of present in-rack sprinkler systems pertains to mounting methods of the sprinklers within the storage racks. Currently, the sprinklers are mounted in an exposed manner within the storage racks, having surrounding guards added for protection. Nevertheless, the sprinklers are susceptible to damage. For example, ingress and egress of commodities into and out of the storage racks, using machinery such as forklifts, often results in contact with, and potential damage to, the sprinklers.

Yet another drawback of the exposed mounting of the sprinklers of present in-rack sprinkler systems is that fire suppression fluid spray from sprinklers located in one level of the storage racks may cool the thermal element of the exposed sprinklers located in underlying levels of the storage racks, and, in turn, cold-solder the underlying sprinklers. In-rack sprinkler systems are often referred to as “intermediate level” protection systems and, in addition to the aforementioned guards, the sprinklers may also be equipped with shields above each sprinkler to protect the operating elements thereof from the discharge of higher-level sprinklers in order to minimize the potential for cold-soldering.

It would, therefore, be advantageous to manufacture and employ a compact sprinkler, e.g., a sprinkler configured for in-rack sprinkler systems. Such compact sprinklers may be qualified as standard spray sprinklers, CMDA sprinklers, or other sprinkler classifications, and may be useful in other applications in addition to addressing fires in storage occupancies.

### BRIEF SUMMARY OF THE DISCLOSURE

Briefly stated, one aspect of the present disclosure is directed to a sprinkler including an axially extending, generally tubular sprinkler frame having an inlet located at a proximal end and extending toward a distal end. A plurality of pins are anchored to the sprinkler frame and extend distally. A fluid deflector is oriented in a first position in a non-operative configuration of the sprinkler and distally slidable along the pins into a second position in an operative configuration of the sprinkler. A thermal trigger is supported by the sprinkler frame in the non-operative configuration of the sprinkler at an axial position distal to the deflector. The sprinkler frame is configured to mount to a fire protection piping network.

In one configuration, the pins terminate at a proximal end thereof within the sprinkler frame.

In any one of the previous configurations, the sprinkler may further include a protective crown slidably mounted upon the sprinkler frame and extending distally beyond the distal end of the sprinkler frame. In one configuration, the protective crown includes a plurality of circumferentially spaced apart air-flow openings. In one configuration, the sprinkler frame comprises an axial axis, and the thermal trigger is a fusible link oriented at an inclined angle to the axial axis and at least partially axially overlaps with the air-flow openings. In one configuration, the fluid deflector remains within an axial extent of the protective crown in both the first and second positions.

In any one of the previous configurations, the proximal section of the sprinkler frame defines a proximal inlet, a distal outlet and an internal fire suppression fluid passageway extending therebetween, and the sprinkler may further include an annular seal configured to seal the distal outlet of the internal fire suppression fluid passageway in the non-operative configuration of the sprinkler, the annular seal being positioned proximally to the fluid deflector.

In any one of the previous configurations, the sprinkler may further include a splitter positioned proximally to the fluid deflector, wherein a peripheral extent of the splitter radially expands in a proximal-to-distal direction. In one configuration, the splitter defines an interior cavity with an aperture at a proximal end thereof.

In any one of the previous configurations, the sprinkler may further include a seal and splitter assembly supported within the sprinkler frame, the seal and splitter assembly configured to support the fluid deflector and a Belleville seal overlying the fluid deflector, the seal and splitter assembly including a splitter overlying the Belleville seal, the splitter being configured to stabilize the fluid deflector in the operative configuration.

One aspect of the present disclosure is also directed to a sprinkler including an axially extending, generally tubular sprinkler frame having a proximal section and a distal section. A fluid deflector is oriented in a first position in a non-operative configuration of the sprinkler and distally slidable into a second position in an operative configuration of the sprinkler. A splitter is positioned proximally to the fluid deflector, wherein a peripheral extent of the splitter radially expands in a proximal-to-distal direction, a thermal trigger is supported by the sprinkler frame in the non-operative configuration of the sprinkler at an axial position distal of the splitter. The sprinkler frame is configured to mount to a fire protection piping network.

In one configuration, the splitter includes a confined, interior cavity with an access aperture at a proximal end thereof. In one configuration, a profile of the interior cavity generally follows an external profile of the splitter.

In any one of the previous configurations, the sprinkler may further include a protective crown slidably mounted upon the sprinkler frame. In one configuration, the protective crown includes a plurality of circumferentially spaced apart air-flow openings.

In any one of the previous configurations, the proximal section of the sprinkler frame defines a proximal inlet, a distal outlet and an internal fire suppression fluid passageway extending therebetween, and wherein the splitter is positioned within the internal fire suppression fluid passageway in the non-operative configuration.

One aspect of the present disclosure is also directed to a sprinkler including an axially extending, generally tubular sprinkler frame having a proximal section and a distal section and a fluid deflector oriented in a first position in a non-operative configuration of the sprinkler and distally slidable into a second position in an operative configuration of the sprinkler. A fusible link is supported by the sprinkler frame in the non-operative configuration of the sprinkler, the fusible link being oriented in an axially inclined manner. The sprinkler frame is configured to mount to a fire protection piping network.

In one configuration, the sprinkler further includes a load bar stabilized within the sprinkler frame in the non-operative configuration of the sprinkler, the load bar being proximally positioned relative to the fusible link. A first lever arm is stabilized by the load bar proximate one end and engaged with the fusible link proximate an opposing end, in the non-operative configuration of the sprinkler; and a second lever arm is stabilized by the load bar proximate one end and engaged with the fusible link proximate an opposing end, in the non-operative configuration of the sprinkler. In one configuration, the second lever arm projects distally further than the first lever arm, thereby orienting the fusible link in the axially inclined manner. In any one of the previous configurations, the first lever arm may be monolithically formed with the load bar and project distally therefrom.

In any one of the previous configurations, the proximal section of the sprinkler frame defines a proximal inlet, a distal outlet and an internal fire suppression fluid passageway extending therebetween, and the sprinkler may further include a Belleville seal configured to seal the distal outlet of the internal fire suppression fluid passageway in the non-operative configuration of the sprinkler, the Belleville seal being positioned proximally to the fluid deflector.

In any one of the previous configurations, the sprinkler may further include a splitter positioned proximally to the fluid deflector, wherein a peripheral extent of the splitter radially expands in a proximal-to-distal direction. In one configuration, the splitter defines an interior cavity with an aperture at a proximal end thereof.

In any one of the previous configurations, the sprinkler may include a protective crown distally extending beyond the distal section of the sprinkler frame, the protective crown including a plurality of circumferentially spaced apart air-flow openings. In one configuration, the fusible link at least partially axially overlaps with the air-flow openings.

In any one of the previous configurations, the sprinkler may further include a pair of pins anchored to the sprinkler frame distally extending, the fluid deflector being slidable along the pair of pins.

In any one of the previous configurations, the sprinkler frame may include a distally extending, convergent nozzle distally terminating in an orifice; a first terraced cavity, distally adjacent to the orifice, the first terraced cavity having a larger diameter than the orifice; a second terraced cavity, distally adjacent to the first terraced cavity, the second terraced cavity having a larger diameter than the first terraced cavity; a third terraced cavity, distally adjacent to the second terraced cavity, the third terraced cavity having a larger diameter than the second terraced cavity; and a lip overhanging the third terraced cavity, the lip defining a smaller diameter than the third terraced cavity. In one configuration, the sprinkler includes a load bar stabilized within the sprinkler frame in the non-operative configuration of the sprinkler, wherein the load bar is located within the third terraced cavity. In one configuration, the lip includes two recesses sized and dimensioned to permit the load bar to be assembled into the sprinkler frame during the manufacture thereof.

One aspect of the present disclosure is also directed to a sprinkler including an axially extending, generally tubular sprinkler frame having a proximal section and a distal section. A protective crown distally extends beyond the distal section of the sprinkler frame, and has a plurality of circumferentially spaced apart air-flow openings. A fluid deflector is oriented in a first position in a non-operative configuration of the sprinkler and distally slidable into a second position in an operative configuration of the sprinkler. The fluid deflector is positioned within an axial extent of the protective crown in the first position. A fusible link is supported by the sprinkler frame in the non-operative configuration of the sprinkler at an axial position within the axial extent of the protective crown, and at least partially axially overlaps with the air-flow openings. The sprinkler frame is configured to mount to a fire protection piping network.

In one configuration, the protective crown distally extends a same axial extent, or axially beyond, a distal extent any other component of the sprinkler.

In any one of the previous configurations, the protective crown defines a circumference and a series of air-flow windows about the circumference, the air-flow windows being sized and configured such that the sprinkler qualifies as a quick response sprinkler.

In any one of the previous configurations, the fluid deflector is positioned within the axial extent of the protective crown in the second position.

In any one of the previous configurations, the fluid deflector is positioned beyond the axial extent of the protective crown in the second position.

In any one of the previous configurations, the protective crown is rotationally fixed to the sprinkler frame.

In any one of the previous configurations, the protective crown is slidably mounted upon the sprinkler frame.

In any one of the previous configurations, the protective crown is monolithically formed with the sprinkler frame.

In any one of the previous configurations, the sprinkler frame is configured to mount to the fire protection piping network via a coupling, whereby the fluid deflector is recessed within at least one of the piping network and the coupling, the thermal trigger is recessed within at least one of the piping network and the coupling, and at least a portion of the sprinkler frame is recessed within at least one of the piping network and the coupling.

In any one of the previous configurations, at least the proximal section is configured to substantially complementarily slidably fit within an outlet of the piping network, thereby being substantially concealed within the outlet.

In any one of the previous configurations, the proximal section of the sprinkler frame defines a proximal inlet, a distal outlet and an internal fire suppression fluid passageway extending therebetween, and a splitter is positioned within the internal fire suppression fluid passageway in the non-operative configuration. In one configuration, a peripheral extent of the splitter radially expands in a proximal-to-distal direction. In any one of the previous configurations, the sprinkler may further include a Belleville seal configured to seal the distal outlet of the internal fire suppression fluid passageway in the non-operative configuration of the sprinkler, the Belleville seal being positioned proximally to the fluid deflector.

In any one of the previous configurations, the sprinkler may further include a seal and splitter assembly supported within the sprinkler frame, the seal and splitter assembly configured to support the fluid deflector and a Belleville seal, the Belleville seal overlying the fluid deflector, the seal and splitter assembly including a splitter overlying the Belleville seal, the splitter being configured to adjust the angle of fire suppression fluid traveling from an internal fire suppression fluid passageway toward the fluid deflector.

One aspect of the present disclosure is also directed to a compact sprinkler, qualified as a standard spray sprinkler. The compact sprinkler includes an axially-extending sprinkler frame having an inlet located at a proximal end and extending toward a distal end, and a passageway extending distally from the inlet through the sprinkler frame. A fluid deflector is mounted upon the frame, the fluid deflector having a first position in a non-operative configuration of the sprinkler, and a second position in an operative configuration of the sprinkler, wherein the inlet and the passageway define a nominal K-factor greater than 5.6.

In one configuration, a distance from a proximal side of the fluid deflector, located in the second position, to the proximal end of the sprinkler frame is less than 1.25 inches.

In any one of the previous configurations, a distance from the proximal end of the sprinkler frame to the distal end of the sprinkler frame is less than 1.7 inches.

In any one of the previous configurations, the sprinkler may further include a crown, and a distance from the proximal end of the sprinkler frame to the distal end of the crown is less than 1.75 inches.

### BRIEF DESCRIPTION OF THE SEVERAL VIEWS OF THE DRAWINGS

The following description of the disclosure will be better understood when read in conjunction with the appended drawings. It should be understood, however, that the disclosure is not limited to the precise arrangements and instrumentalities shown. In the drawings:

FIG. 1A is a schematic, perspective view of a storage occupancy, in-rack sprinkler system piping network;

FIG. 1B is a partial, cross-sectional view of a branchline of the in-rack sprinkler system piping network of FIG. 1A, taken along sectional line 1B-1B, having a branchline outlet for mounting a sprinkler thereto;

FIG. 2 is a front, elevational view of sprinkler in accordance with a first embodiment of the present disclosure, mounted to a branchline outlet via a coupling and predominantly concealed therein, the sprinkler being in a non-operative configuration and depicting the removable cap;

FIG. 3 is a partial, cross-sectional view of the branchline outlet, sprinkler and coupling of FIG. 2, taken along sectional line 3-3;

FIG. 4 is a front elevational view of the sprinkler of FIG. 2, in the non-operative configuration thereof;

FIG. 5 is a cross-sectional view of the sprinkler of FIG. 4 in the non-operative configuration thereof, taken along sectional line 5-5;

FIG. 6 is a cross-sectional view of the sprinkler of FIG. 4 in the non-operative configuration thereof, taken along sectional line 6-6;

FIG. 7 is a cross-sectional view of the sprinkler of FIG. 4 in the operative configuration thereof, taken along sectional line 6-6;

FIG. 8 is a cross-sectional view of a sprinkler in accordance with a second embodiment of the present disclosure, mounted to a branchline outlet via a coupling and predominantly concealed therein, the sprinkler being in a non-operative configuration and depicting the removable cap;

FIG. 9 is a cross-section view of the sprinkler of FIG. 8, mounted to the branchline outlet via the coupling, the sprinkler being in the operative configuration;

FIG. 10 is a perspective view of a sprinkler in accordance with a third embodiment of the present disclosure, the sprinkler being in a non-operative configuration and having a coupling mounted thereto;

FIG. 11 is a top perspective view of the sprinkler of FIG. 10 with the coupling mounted thereto;

FIG. 12 is a side elevational view of the sprinkler of FIG. 10;

FIG. 13 is an exploded, side elevational view of the sprinkler of FIG. 10;

FIG. 14 is a side elevational cross-sectional view of the sprinkler of FIG. 10 in the non-operative configuration, taken along the sectional line 14-14 of FIG. 12;

FIG. 15 is a front elevational cross-sectional view of the sprinkler of FIG. 10 in the non-operative configuration and depicting the removable cap, taken along the sectional line 15-15 of FIG. 11;

FIG. 16 is a side elevational cross-sectional view of the sprinkler of FIG. 10 in the operative configuration, taken along the sectional line 16-16 of FIG. 11;

FIG. 17 is a bottom plan view of the sprinkler of FIG. 10; and

FIG. 18 is a side elevational cross-sectional view of a sprinkler in accordance with a fourth embodiment of the present disclosure, taken along the sectional line 14-14 of FIG. 12, the sprinkler being in the non-operative configuration.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the sprinkler system and/or compact sprinkler, and designated parts thereof, in accordance with the present disclosure. In describing the sprinkler system and/or compact sprinkler, the term proximal is used in relation to the end of the device closer to the associated branchline and the term distal is used in relation to the end of the device further from the associated branchline. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

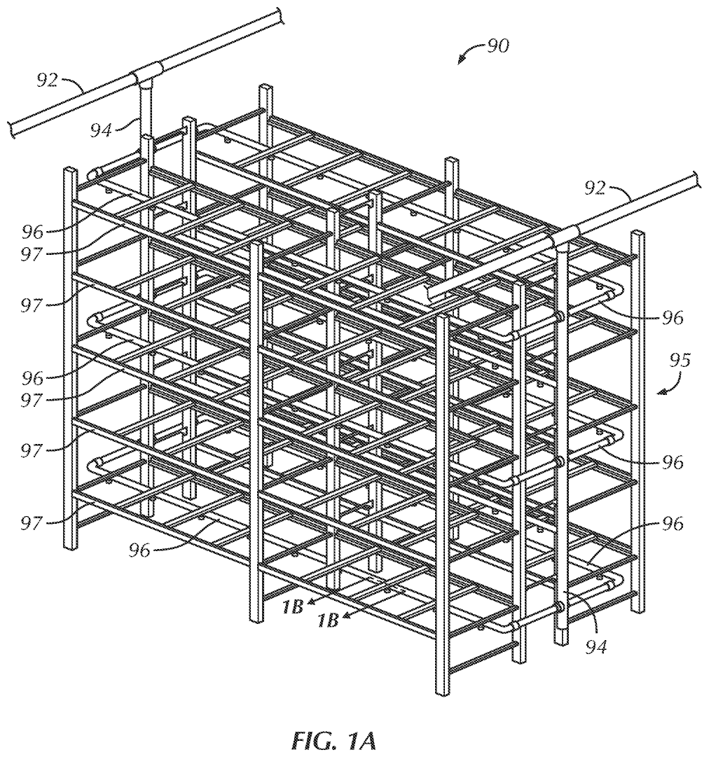

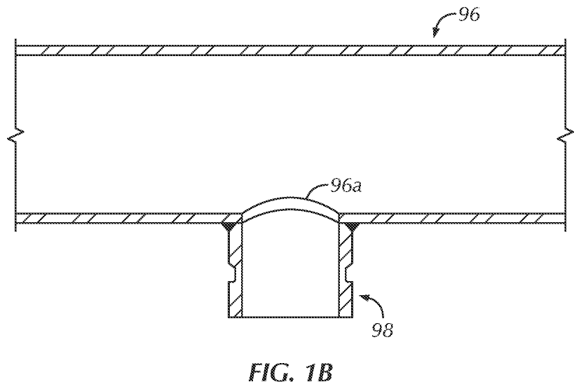

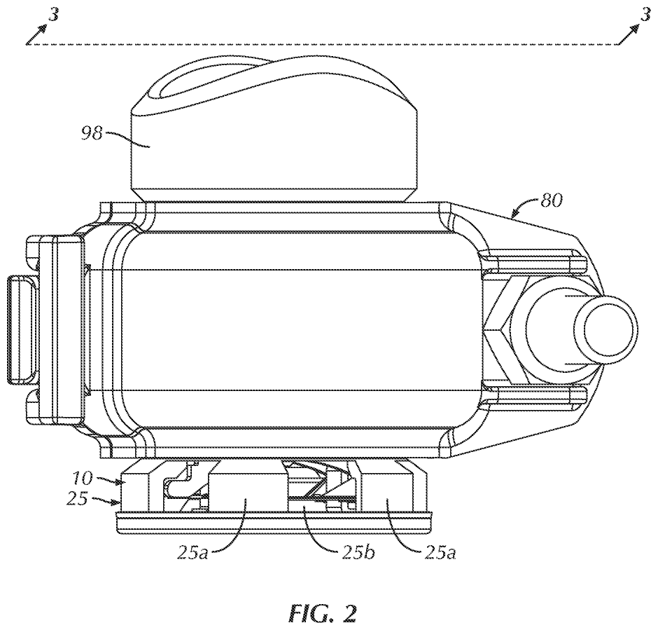

Referring to the drawings in detail, wherein like numerals indicate like elements throughout, there is shown in FIGS. 2-7 a sprinkler 10, in accordance with a first embodiment of the present disclosure. In one non-limiting configuration, the sprinkler 10 is configured for use in an in-rack sprinkler system 90 (as shown schematically in FIG. 1A). As should be understood by those of ordinary skill in the art, an in-rack sprinkler system 90 is generally employed in multi-level racked storage areas, warehouses or other facilities, and may be a wet or dry system. An in-rack sprinkler system 90 typically includes a plurality of cross-main conduits 92 laterally extending throughout an occupancy. Riser conduits 94 are fluidly connected to, and generally vertically extend from, the cross-main conduits 92 proximate individual arrays 95 of multi-level storage racks 97. At least one branchline 96 is fluidly connected to, and generally horizontally extends from, a riser conduit 94 and through each level of storage racks 97.

The branchlines 96 include a plurality of spaced apart outlets 98 (see example of a single outlet 98 in FIG. 1B) for mounting of respective sprinklers thereto. That is, the outlets 98 form a component of branchlines 96. In one configuration, as shown in FIG. 1B, the outlets 98 may be welded onto corresponding through-apertures 96a in the sidewalls of the branchlines 96. As one example, without limitation, the outlets 98 may take the form of Victaulic No. 142 Saddle-Cut Welded Outlets sold by Victaulic Company. The disclosure, however, is not so limited. For, example, the outlets 98 may be fastened to the branchlines 96 via other fastening means currently known, or later become known, such as, for example, without limitation, via a mechanical tee connection, or the outlets 98 may be monolithically formed with the branchlines 96. As also should be understood by those of ordinary skill in the art, the outlets 98 may extend from the branchline 96 in an orientation for upright sprinkler mounting, pendent sprinkler mounting, sidewall sprinkler mounting, or a combination thereof. The sprinkler 10 is mounted to an outlet 98 as will be described in further detail below.

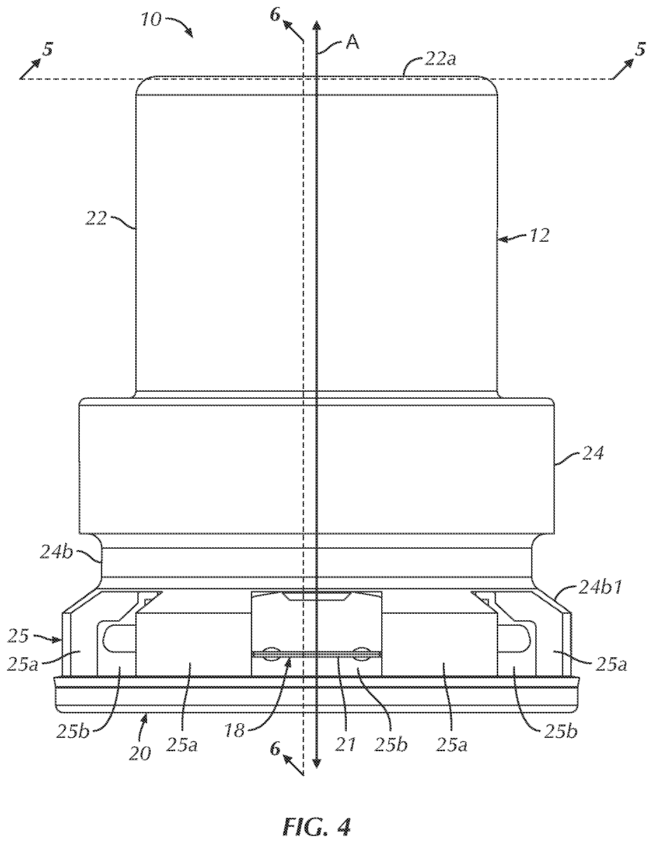

As shown best in FIGS. 4-7, the sprinkler 10 includes a sprinkler frame 12, a seal and splitter assembly 14, a fluid deflector 16, a heat sensor/thermal trigger (i.e., heat-sensitive element) 18 and a removable cap 20. The sprinkler frame 12 is generally tubular, i.e., elongate in the direction of axial axis A, having a proximal section 22 and a distal section 24. As should be understood, the term “tubular” is not limited to an axially elongate body having a circular cross-section and uniform internal and external cross-sectional peripheral dimensions. Rather the term “tubular” includes axially elongate bodies having any of non-circular shapes in cross-section, varying internal cross-sectional peripheral dimensions and varying external cross-sectional peripheral dimensions. The proximal section 22 defines a proximal inlet 22a, a distal outlet 22b and an internal fire suppression fluid passageway 22c extending therebetween. In a wet system, the branchline 96 is in continuous fluid communication with the internal fire suppression fluid passageway 22c. In the illustrated embodiment, the distal section 24 generally defines a greater external diameter (or external cross-sectional peripheral dimension) than an external diameter (or external cross-sectional peripheral dimension) of the proximal section 22 and generally defines a greater internal diameter (or internal cross-sectional peripheral dimension) than an internal diameter (or internal cross-sectional peripheral dimension) of the proximal section 22, but the disclosure is not so limited.

As shown in FIGS. 2-7, a crown 25 forms the distal end of the distal section 24. The crown 25 includes a plurality of spaced apart distally extending tabs/teeth 25a forming a periphery, e.g., a circumferential periphery, of the crown 25, with respective air-flow openings/apertures 25b therebetween. The cap 20 is removably attached to a distal end of the crown 25. In one configuration, the cap 20 may serve as a protective shield during transport, installation or the like, upon the otherwise open distal end of the sprinkler frame 12, and which may be removed after installation of the sprinkler 10. Alternatively, the cap 20 may take the form of a cover plate, welded onto the sprinkler frame 12, e.g. onto the crown 25, wherein the welding material (e.g., solder) may have a sufficiently low melting point (e.g., without limitation, between approximately 100° F. and approximately 120° F.), such that when the cover plate 20 is heated to, or above, the melting point of the welding material, the cover plate falls off the sprinkler frame 12.

The distal outlet 22b of the fire suppression fluid passageway 22c is sealable via the seal and splitter assembly 14, which includes a splitter 26 attached to an underlying base-body 27. The base-body 27 includes a central post 27a having a radially outwardly extending flange 27b. A proximal, terminal end of the central post 27a includes a first socket 27c formed therein. A distal, terminal end of the central post 27a, distally spaced from the radially outwardly extending flange 27b, includes a second socket 27d bound by a radially outwardly extending lip 27e.

The spacing along the central post 27a, between the radially outwardly extending flange 27b and the radially outwardly extending lip 27e, is configured to securely receive the deflector 16 therein, and thus the deflector 16 is supported at least in part by the underlying radially outwardly extending lip 27e. In one configuration, for example, the deflector 16 is first mounted onto the central post 27a (via a central aperture of the deflector 16), abutting an underside of the first radially outwardly extending flange 27b, and then the terminal end of the central post 27a is swaged or otherwise mechanically attached to form the radially outwardly extending lip 27e along the underside of the deflector 16 to thereby sandwich the deflector 16 between the radially outwardly extending flange 27b and the radially outwardly extending lip 27e.

In the illustrated embodiment, the seal takes the form of an annular seal, e.g., a Belleville washer or disk functioning as a seal 28, but the disclosure is not so limited. The Belleville seal 28 is sealingly mounted upon the central post 27a of the base-body 27 (via a substantially central aperture thereof as understood by those of ordinary skill in the art) and positioned upon the first radially outwardly extending flange 27b. In one configuration, the central aperture of the Belleville seal 28 and the central post 27a form an interference fit therebetween. Face-to-face engagement between the Belleville seal 28 and the underlying first radially outwardly extending flange 27b also enhances seal integrity. As should be understood by those of ordinary skill in the art (and as will be further described below) the Belleville seal 28 is employed to seal the sprinkler 10 in a concealed/non-activated, i.e., no-spray, configuration.

In the non-activated configuration of the sprinkler 10, the splitter 26 is positioned within the internal fire suppression fluid passageway 22c. The splitter 26 is mounted upon the base-body 27. As shown, the splitter 26 is generally conical in shape and generally triangular in cross-section and includes a plug 26a axially projecting outwardly from an underside of the base thereof. The plug 26a is configured to securely insert into the socket 27c of the base-body 27 to secure the splitter 26 upon the base-body 27. In the illustrated configuration, the side wall 26b of the splitter 26, i.e., from the apex to the base thereof, is generally concave, but the disclosure is not so limited. As will be described in further detail below, the splitter 26 is configured, e.g., via dimension and shape, to adjust the angle of the fire suppression fluid traveling from the internal fire suppression fluid passageway 22c toward the fluid deflector 16 to generally bypass the intervening Belleville seal 28 and contact the fluid deflector 16.

In the illustrated embodiment, the thermal trigger 18 takes the form of a fusible link 21, but the disclosure is not so limited as the sprinkler 10 may employ any type of thermal trigger 18 currently known, or that later becomes known, such as, for example, without limitation, a glass-bulb type trigger. Advantageously, however, a fusible link 21 is generally laterally oriented rather than axially oriented, assisting in minimizing the axial footprint of the non-operative configuration of the sprinkler 10.

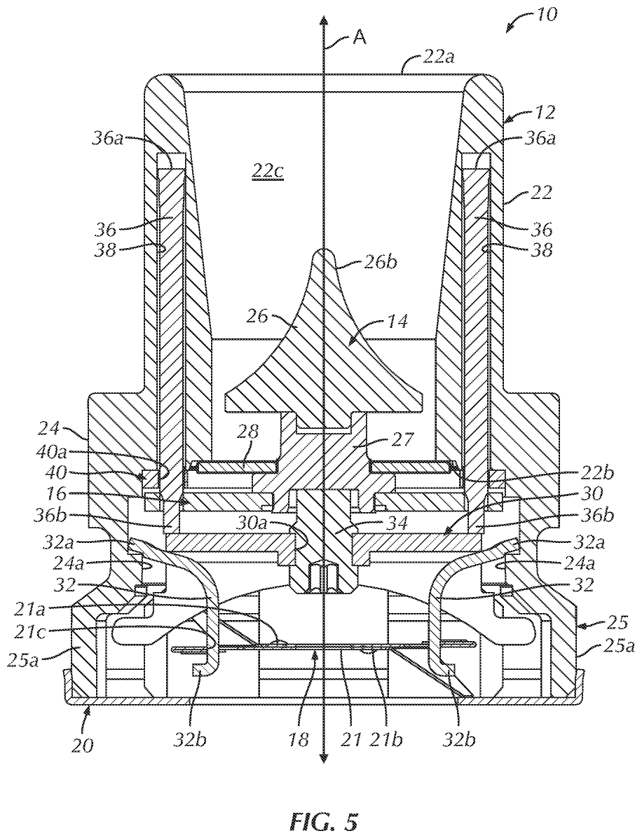

The fusible link 21 (when intact) also contributes to holding the Belleville seal 28 in place against the distal outlet 22b of the proximal section 22 of the sprinkler frame 12 in the non-activated configuration of the sprinkler 10. As shown best in FIG. 5, the sprinkler 10 further includes a load bar 30 and a pair of generally arcuate lever arms 32 generally positioned between the seal and splitter assembly 14 and the fusible link 21. The distal section 24 of the sprinkler frame 12 also includes a ledge 24a radially inwardly extending from an inside sidewall thereof. Within the distal section 24, the lever arms 32 are positioned opposite one another, e.g., diametrically opposed, about the axial axis A, with respective first, proximal ends 32a thereof axially supported upon the ledge 24a. The load bar 30 is axially supported upon the proximal ends 32a of the lever arms 32, securing the lever arms 32 upon the ledge 24a. The generally arcuate lever arms 32 distally extend along the axial axis A into engagement with the fusible link 21. As shown, each lever arm 32 projects through a corresponding aperture 21c of the fusible link 21. As described further below, the load bar 30 generates an axial load onto the proximal ends 32a of the opposing arcuate lever arms 32, which creates a radially outwardly directed torque upon each of the distal ends 32b of the arcuate lever arms 32, thereby resulting in a tensile force on the fusible link 21 (via contact with the periphery of the apertures 21c) which contributes to axially stabilizing the fusible link 21. Additionally, or alternatively, the respective terminal distal ends 32b of the lever arms 32, axially underlying the fusible link 21, may each take the form of a ledge, upon which the fusible link 21 may be axially supported.

The load bar 30 includes a central, threaded thru-hole 30a, axially aligned with the second socket 27d of the base-body 27. An externally threaded load screw 34 is threaded with the thru-hole 30a and projects into the second socket 27d. Upon engagement of the proximal end of the load screw 34 with the closed end of the second socket 27d, additional advancement of the load screw 34 (via further threading with the thru-hole 30a) drives the seal and splitter assembly 14 proximally toward the internal fire suppression fluid passageway 22c until the Belleville seal 28 is sufficiently pressed against the distal outlet 22b of the passageway 22c to form the fluid-tight seal. The Belleville seal 28 is sufficiently pressed against the distal outlet 22b of the passageway 22c to counteract the upstream pressurized fire suppression fluid in the fire suppression fluid passageway 22c and maintain the seal until the sprinkler 10 is activated by a fire event.

Upon engagement of the load screw 34 with the closed end of the second socket 27d, further threading with the thru-hole 30a also distally presses the load bar 30 against the proximal ends 32a of the lever arms 32 (and against the underlying ledge 24a). The axial load generated by the load bar 30 onto the proximal ends of the arcuate lever arms 32 creates a radially outwardly directed torque upon the distal ends 32b of the arcuate lever arms 32, thereby resulting in a tensile force on the fusible link 21. The fusible link 21 is configured to remain intact (in the absence of a fire event), and thereby withstand and counteract the tensile forces thereon. Accordingly, when the fusible link is intact, a force equilibrium is created between the fire suppression fluid within the fluid passageway 22c, the seal and splitter assembly 14, the load bar 30, the lever arms 32 and the fusible link 21 to maintain the Belleville seal 28 sufficiently sealed against the distal outlet 22b of the passageway 22c until the sprinkler 10 is activated by a fire event.

As should be understood by those of ordinary skill in the art, and as will be described in further detail below, upon activation of the thermal trigger 18, e.g., when the solder between the two metal plates 21a, 21b of the fusible link 21 reaches the designated temperature at which the solder melts and the two metal plates thereof detach from each other (as understood by those of ordinary skill in the art), the Belleville seal 28 is overcome by the upstream pressurized fire suppression fluid from within the fluid passageway 22c, and the fire suppression fluid sprays out from the passageway 22c and guided by the splitter 26 to impact the deflector 16 for distribution thereof in a desired spray pattern according to the design of the deflector 16, e.g., directed into the respective storage rack 97. When heated to or above a predetermined temperature, the thermal trigger 18 may break, shrink, shatter or otherwise separate, thus disrupting the force equilibrium keeping the Belleville seal 28 in place, and thereby permitting the fire suppression fluid to flow onto the deflector 16. In one non-limiting configuration, the fusible link 21 may have a temperature rating, i.e., the temperature at which the fusible link 21 separates, between approximately 125° F. and approximately 300° F., such as, for example, without limitation, approximately 165° F., approximately 212° F. and approximately 286° F. In one non-limiting configuration the sprinkler 10 is configured to operate at a water pressure between approximately 7 psi and approximately 300 psi, such as, for example, between approximately at 10 psi and approximately 175 psi.

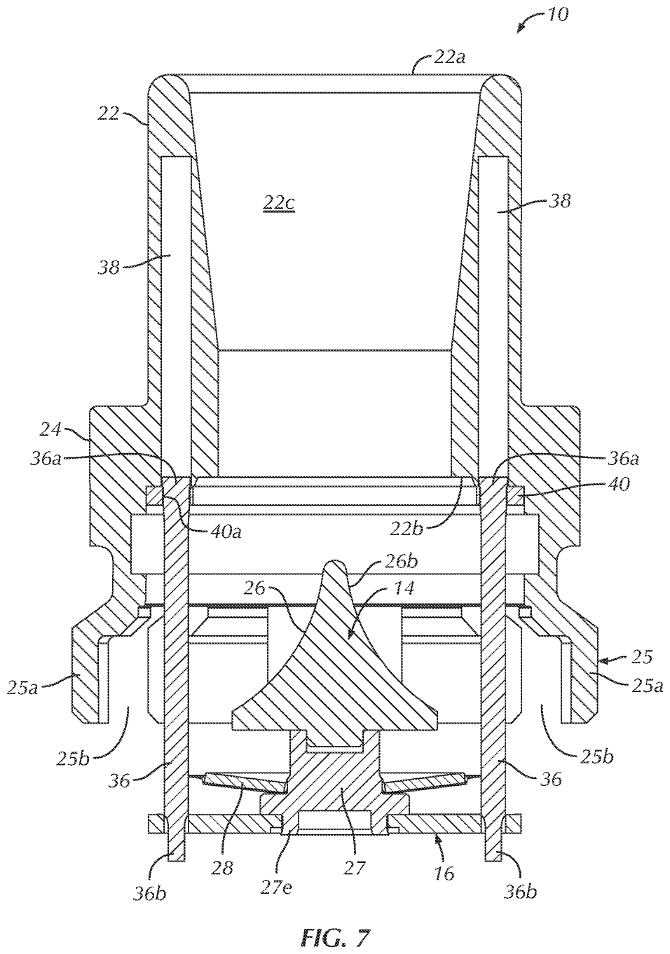

As shown best in FIGS. 5 and 7, the sprinkler 10 may further include a plurality of axially-directed drop pins 36 in slidable engagement with the sprinkler frame 12. In the illustrated embodiment, there are a pair of drop pins 36 oppositely disposed within the sprinkler frame 12, e.g., diametrically opposed, and slidably, e.g., telescopically, received within respective axially-directed channels 38 bored out in the sprinkler frame 12. As should be understood, the channels 38 are dimensioned to permit telescoping of the drop pins 36 therewith. In the illustrated embodiment, the channels 38 are bored out in the sidewall of a portion of the proximal section 22 and a portion of the distal section 24 of the sprinkler frame 12, but the disclosure is not so limited. The drop pins 36 are secured to the deflector 16 proximate the distal ends 36b thereof in a manner well understood by those of ordinary skill in the art, e.g., without limitation, via welding, latching, swaging (e.g., riveting), a combination thereof or the like. For example, the respective distal ends 36b of the drop pins 36 shown in FIGS. 5 and 7 may still be riveted to axially secure the deflector 16 to the drop pins 36.

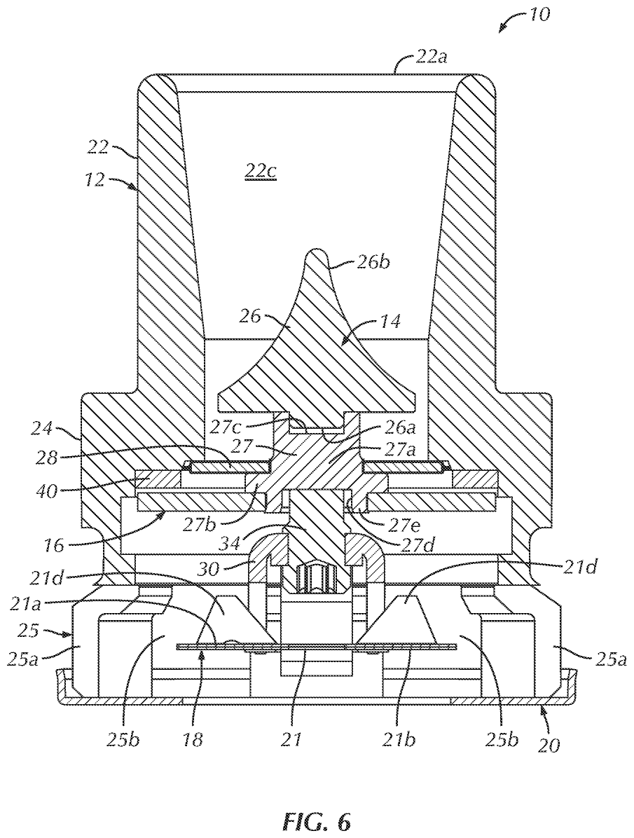

In the compressed, non-activated state of the sprinkler 10, as shown in FIG. 6, the drop pins 36 are telescopically withdrawn and/or retracted within the respective channels 38, i.e., proximally withdrawn and recessed within the sprinkler frame 12, and the deflector 16 is positioned within the sprinkler frame 12, such as, for example, without limitation, within the distal section 24 and proximally to the crown 25. As shown, the drop pins 36 are not in contact with the fire suppression fluid when withdrawn in the channels 38 in the non-activated state. In the non-activated state, the deflector 16 is also retracted/concealed within, and protected by, the sprinkler frame 12. In one configuration, as shown, for example, in FIG. 6, the deflector 16 may be positioned proximate the distal end 22b of the fire suppression fluid passageway 22c, but the disclosure is not so limited. In an extended, operational position of the sprinkler 10, as shown in FIG. 7, the drop pins 36 and the deflector 16 are slidably extended/dropped down, i.e., slid down the channels 38, through respective open distal ends of the channels 38.

As shown in FIGS. 5-7, the sprinkler frame 12 includes a retainer clip 40 secured adjacent the open distal ends of the channels 38. In one non-limiting example, the retainer clip 40 may be press-fit into a corresponding orifice underlying the open distal ends of the channels 38. The retainer clip 40 includes a respective thru-hole 40a axially aligned with each of the channels 38. The thru-holes 40 are dimensioned to permit sliding of the drop pins 36 therethrough. The thru-holes 40a are sized slightly smaller than the channels 38, however. Accordingly, a proximal collar 36a of each drop pin 36, sized larger than a remainder of the drop pin 36, e.g., having a greater diameter, is slidable through the corresponding channel 38, but is stopped by the retainer 40 as a result of being larger than the corresponding thru-hole 40a. Thus, the retainer clip 40 restricts the axial distance that the deflector 16 travels from the non-activated to the operational state of the sprinkler 10 (as will be described in further detail below).

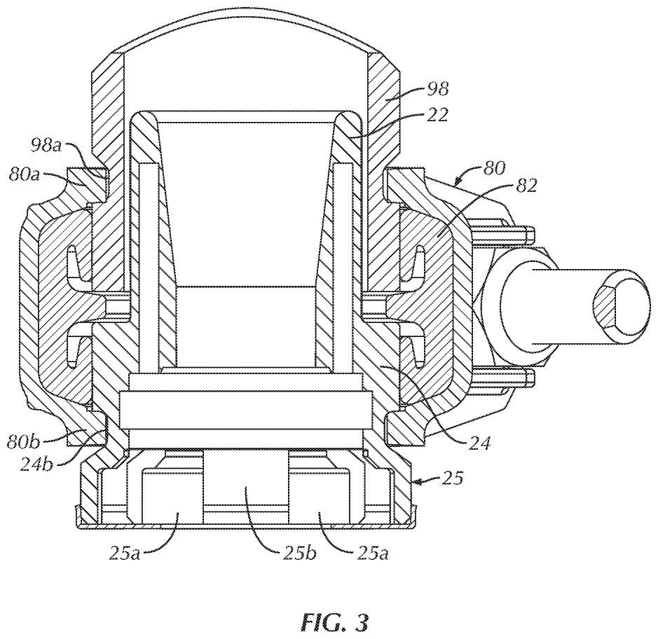

Referring back to FIGS. 2 and 3, the sprinkler 10 is shown mounted to a branchline outlet 98 via a coupling 80. In one non-limiting example, the coupling 80 may take the form of a Victaulic FireLock™ V9 coupling sold by Victaulic Company. As shown best in FIG. 3, the generally tubular proximal section 22 of the sprinkler frame 12 is dimensioned to be substantially complementarily, slidably received within the branchline outlet 98, and the coupling 80 is fastened around an external portion of the branchline outlet 98 and an external portion of the sprinkler frame 12. As shown, the coupling 80 may include an internal gasket 82 interposed between the coupling 80 and the branchline outlet 98 and sprinkler frame 12. The branchline outlet 98 may include an external peripheral groove 98a and the sprinkler frame 12 may include an external peripheral groove (distally spaced from the branchline groove 98) about a portion thereof not recessed within the branchline outlet 98, e.g., along a portion of the distal section 24, thereby forming proximal and distal grooves for corresponding lips 80a, 80b of the coupling 80 to latch onto and fasten the sprinkler 10 to the branchline outlet 98 in a fluid-tight manner.

As should be understood, the sprinklers of the present disclosure are not limited to being mounted, e.g., via the coupling 80, to an in-rack sprinkler system, but rather may be employed in other fire protection systems, including those where the branchlines are located proximate to the ceiling of the occupancy. As also should be understood, the sprinkler 10 of the present disclosure is not limited to mounting to the branchline outlet 98 via a coupling 80, but may be mounted thereto via other means, currently known or that later become known, which provide the functionality and advantages described herein. As one non-limiting alternative example (described below), the proximal section 22 of the sprinkler frame 12 may be externally threaded and the branchline outlet 98 may be internally threaded, such that, at least the proximal section 22 of the sprinkler frame 12 is concealed within the branchline outlet 98. In another non-limiting alternative example, the proximal section 22 may be snap fit into the branchline outlet 98, such that at least the proximal section 22 is concealed within the branchline outlet 98.

In the illustrated embodiment, as shown best in FIG. 4, the external peripheral groove 24b is located adjacent a proximal end of the crown 25, wherein the distal ledge 24b1 of the groove 24b defines a common boundary with the crown 25. That is, the distal ledge 24b1, which as shown in FIGS. 2 and 3 is a non-loadbearing ledge of the groove 24b, defines a proximal portion of the tabs 25a of the crown 25. Similarly, notches in distal ledge 24b1 define a proximal portion of the air-flow apertures 25b, whereby the air-flow apertures 25b extend from the distal end of the sprinkler frame 12 and terminate in the external peripheral groove 24b.

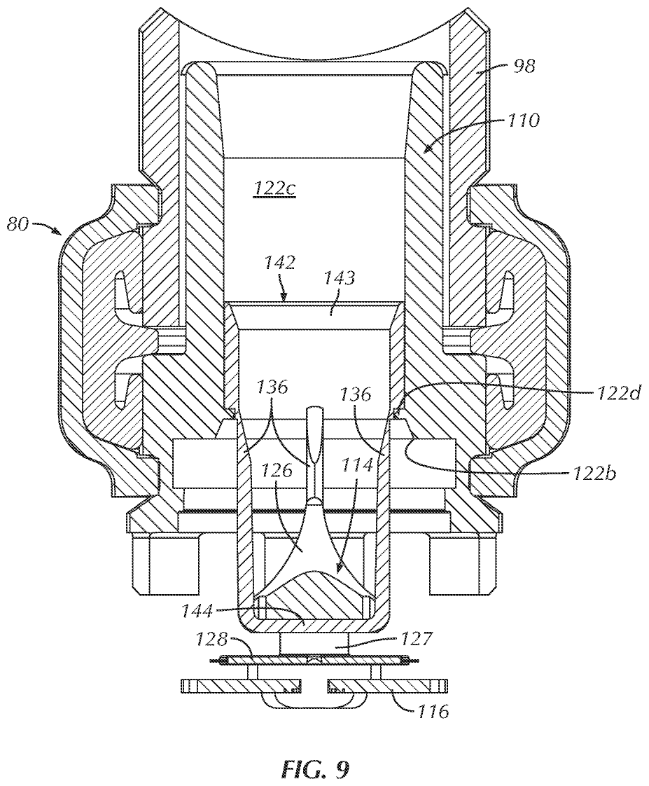

As shown best in FIG. 6, the fusible link 21 is axially positioned entirely within the crown 25 in the non-operative configuration of the sprinkler 10. That is, in addition to the metal plates 21a, 21b of the fusible link 21 being positioned within the crown 25, heat collector fins 21d projecting generally axially and proximally from the proximal metal plate 21a of the fusible link 21 are located within the axial extent/depth of the air-flow apertures 25b. Stated differently, the air-flow apertures 25b define a proximal extent, proximally extending beyond the heat collector fins 21d of the fusible link. The disclosure, however, is not so limited (see, e.g., FIG. 9). As also shown best in FIG. 6, the fusible link 21 may be angularly mounted within the crown 25, such that each of the heat collector fins 21d is angularly aligned with at least one of the air-flow apertures 25b. Advantageously, therefore, the axial extent of the air-flow apertures 25b relative to the elevational position of the fusible link 21, in combination with the angular alignment of the heat collector fins 21d with the air-flow apertures 25b, maintains sufficient airflow to the fusible link 21 for the proper function thereof (as previously described and should be understood by those of ordinary skill in the art).

Advantageously, the generally tubular sprinkler frame 12 provides protection to the operative components of the sprinkler 10, which are retracted/concealed within the sprinkler frame 12 in the non-operative state of the sprinkler 10. For example, in the non-operative state, the drop pins 36 are positioned within the respective channels 38 and the splitter 26 is positioned within the fire suppression fluid passageway 22c. Additionally, the greater external, peripheral dimension of the distal section 24, relative to the proximal section 22 of the sprinkler frame 12, assists in protecting operative components such as the deflector 16, the thermal element 18 and the connecting elements therebetween, recessed within the distal section 24 in the non-operative state of the sprinkler 10. Further advantageously, the mounting relationship between the sprinkler 10 and the branchline 96 (via the outlet 98 thereof) results in a predominantly concealed sprinkler frame 12 providing an additional layer of protection for the internal, operative sprinkler 10 components necessary to the successful operation thereof. For example, in the illustrated embodiment with the internal peripheral groove 24b positioned proximally adjacent to the crown 25, the branchline outlet 98 and the coupling 80 conceal and protect the entirety of the sprinkler frame 12, and the components therein, proximal to the crown 25. That is, at least the seal and splitter assembly 14, including the deflector 16, are concealed within the branchline outlet and/or the coupling 80. In addition to the previously described advantages of the crown 25 structure, e.g., with respect to airflow, the tabs/teeth 25a of the crown 25 are also configured to operate as a guard for protective purposes of the internal operative components of the sprinkler 10, eliminating the necessity of a dedicated, external guard. Yet further advantageously, concealment of sprinkler 10 within the branchline outlet 98 also functions as a shield against cold-soldering from elevationally higher sprinklers, eliminating the necessity of a dedicated, external shield.

In operation, the sprinkler 10 is mounted onto the branchline 96 e.g., in the manner previously described, in a pendent orientation. As previously described, the sprinkler 10 is maintained in the non-operative configuration in the absence of a fire/thermal event. Though concealed, the air-flow apertures 25b advantageously maintain adequate airflow to the thermal trigger 18. Accordingly, in the instance of a fire/thermal event, when temperature reaches or exceeds the melting point of solder in fusible link 21, the two metal plates of the fusible link 21 detach from each other, disrupting the previously described force equilibrium maintaining the Belleville seal 28 in sealing engagement with the distal outlet 22b of the passageway 22c. Namely, the lever arms 32 are no longer held in place by the fusible link and may fall away, resulting in the load bar 30 and the load screw 34 also falling away. The Belleville seal 28 is, thus, overcome by the upstream pressurized fire suppression fluid from within the fluid passageway 22c, thereby driving the seal and splitter assembly 14, into the operational position of the sprinkler 10, as shown in FIG. 7. The deflector 16, attached to the assembly 14 is also driven down, along with the drop pins 36 attached to the deflector. The drop pins 36 slide down the corresponding channels 38 until the respective proximal ends 36a thereof are stopped by the retaining clip 40, thereby stabilizing the seal and splitter assembly 14 and the attached deflector 16 in the operational position thereof. In the illustrated embodiment, the deflector 16 is axially advanced beyond the crown 25 in operational position, but the disclosure is not so limited. The fire suppression fluid sprays out from the passageway 22c and is guided by the splitter 26 to impact the deflector 16 for distribution thereof in a desired spray pattern according to the design of the deflector 16, e.g., directed into the respective storage rack 97. As should be understood, if the cap 20 is attached to the sprinkler frame 12 (via a direct or indirect solder joint), the solder material of the cap 20 would also be configured to melt and allow the cap 20 to fall away with, or prior to, the fusible link 21.

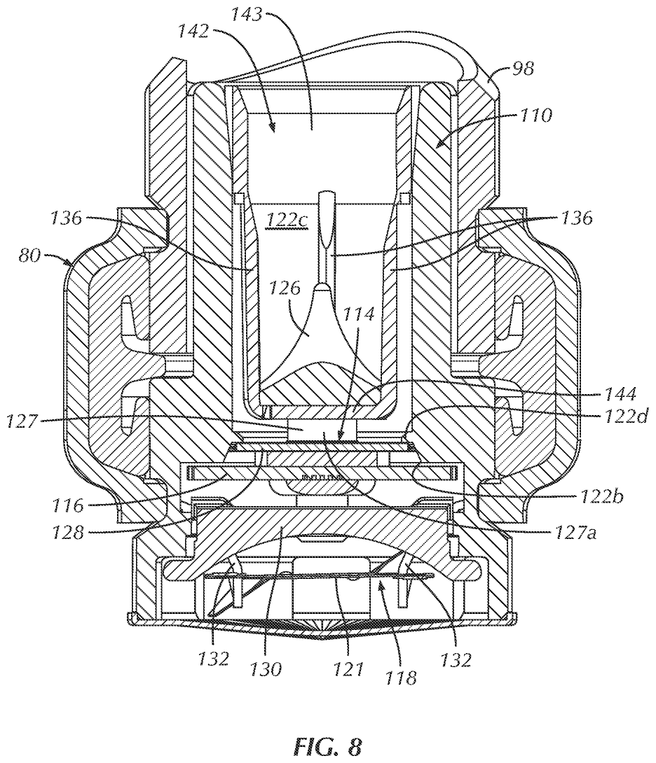

FIGS. 8-9 illustrate a second embodiment of a sprinkler 110. The reference numerals of the second embodiment are generally distinguishable from those of the above-described first embodiment (FIGS. 2-7) by a factor of one hundred (100), but otherwise indicate the same elements as indicated above, except as otherwise specified. The sprinkler 110 of the present embodiment is similar to that of the first embodiment. Therefore, the description of certain similarities and modes of operation between the embodiments may be omitted herein for the sake of brevity and convenience, and, therefore, is not limiting.

A primary difference between the sprinkler 110 of the second embodiment and the sprinkler 10 of the first embodiment pertains to the drop-down mechanism of the operational internal components from the non-operative configuration/retracted position to the operative configuration/extended position. Rather than employ drop pins 36 slidable through channels 38 formed in the sidewall of the sprinkler frame 12, as previously described with respect to the sprinkler 10 of the first embodiment, the sprinkler 110 includes a slidable support assembly 142 in slidable engagement with the internal fire suppression fluid passageway 122c. The slidable support assembly 142 includes a proximal ring 143. A plurality of pins 136 axially, distally extend from the ring 143 to the underlying seal and splitter assembly 114. In the illustrated embodiment, three pins 136 distally extend from the ring 143, but the disclosure is not so limited. As should be understood, two, four or more pins 136 may be employed. In the illustrated embodiment, the pins 136 axially extend to a base plate 144 connecting the pins 136 at the distal ends thereof. The base plate 144 is configured to mount upon the central post 127a of the base-body 127 (via a substantially central aperture thereof as understood by those of ordinary skill in the art). The radial periphery of the central aperture of the base plate 144 is smaller than the radial periphery of the base of the splitter 126, and therefore the base plate 144 abuts the base of the splitter 126 when mounted upon the base-body 127. Accordingly, the seal and splitter assembly 114 may be elevationally supported by the slidable support assembly 142.

In the retracted/concealed, non-operative state of the sprinkler 110 (FIG. 8), the annular seal, e.g., Belleville seal 128, is pressed against a ledge 122d, proximate the distal outlet 122b of the passageway 122c and radially inwardly protruding into the passageway 122c, to form the fluid-tight seal, via the same components and equilibrium of forces previously described with respect to the sprinkler 10 of the first embodiment.

In the instance of a fire/thermal event, the force equilibrium is disrupted as previously described, resulting in the falling away of the fusible link 121, the lever arms 132 and the load bar 130, whereby the seal and splitter assembly 114 is driven into the operational position of the sprinkler 110 (FIG. 9). Accordingly, the slidable support assembly 142 slides distally through the fire suppression fluid internal passageway 122c. The pins 136 are sufficiently radially spaced inwardly from the periphery of the passageway 122c to slide past the radially inwardly protruding ledge 122d. Conversely, the ring 143 is dimensioned to engage the ledge 122d. Thus, the ring 143 slides distally through the passageway 122c until the ring 143 abuts, and is stopped by, the radially inwardly protruding ledge 122d, stabilizing the seal and splitter assembly 114, and the attached deflector 116 in the operational position thereof.

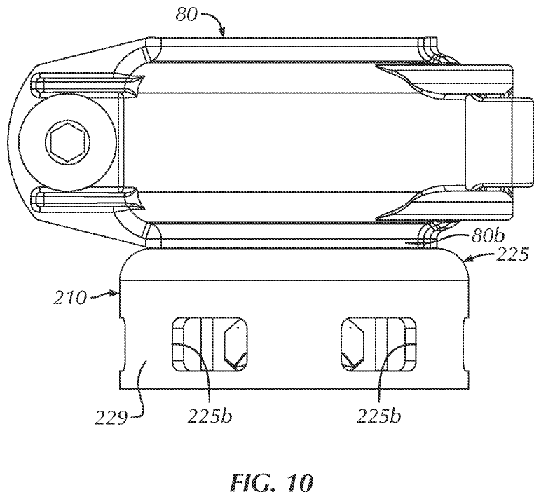

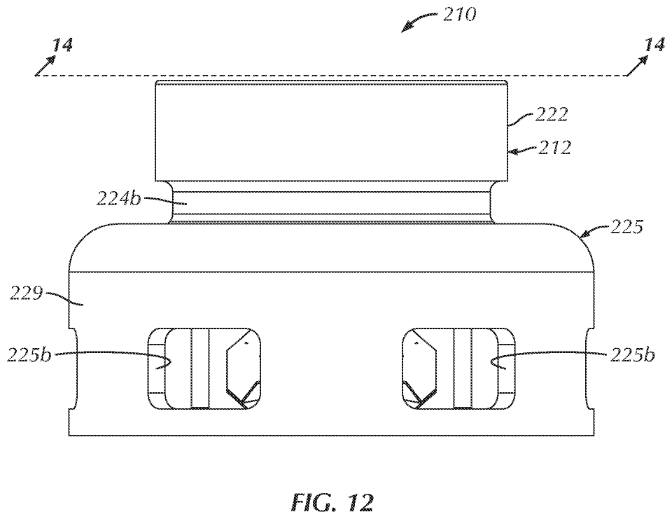

FIGS. 10-17 illustrate a compact sprinkler 210, according to a third embodiment of the present disclosure. The reference numerals of the second embodiment are generally distinguishable from those of the above-described first and second embodiments (FIGS. 1-9) by a factor of one hundred (100), but otherwise indicate the same elements as indicated above, except as otherwise specified. The compact sprinkler 210 of the present embodiment is similar to that of the first and second embodiments and may likewise be employed in an in-rack sprinkler system. Therefore, the description of the sprinkler 210 will generally focus on the differences from the previous embodiments and certain similarities and modes of operation between the embodiments may be omitted herein for the sake of brevity and convenience, and, therefore, is not limiting.

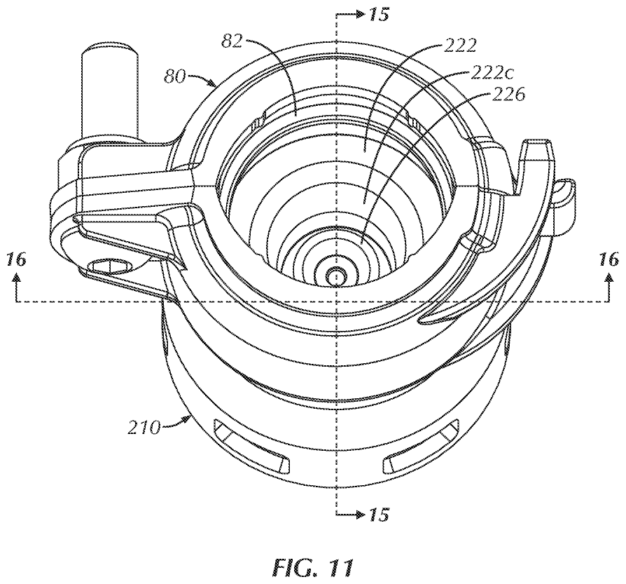

One difference between the sprinkler 210 of the third embodiment and the sprinklers 10 and 110 of the first and second embodiments is that the sprinkler 210 is more compact. That is, the axial extent of the sprinkler frame 212 is shortened relative to the axial extents of the sprinkler frames 12, 112 of the sprinklers 10, 110, respectively. In one non-limiting example, and as shown best in FIGS. 10 and 11, where the coupling 80 is utilized to mount the sprinkler 210 to the branchline outlet 98, the axial extent of the proximal section 222 is shorter than the axial extent of the coupling 80. For example, the proximal section 222 may axially extend approximately midway into the coupling 80, but the disclosure is not so limited. In one non-limiting example, the proximal section 222 may define an axial extent less than half the axial extent of the coupling 80. Accordingly, the proximal section 222 does not extend into the branchline outlet 98 when mounted thereto via the coupling 80. Alternatively, however, as should be understood by those of ordinary skill in the art, the sprinkler 210 may be mounted to the branchline outlet 98 via other mechanisms currently known or that later become known. For example, without limitation, the branchline outlet 98 may include internal threads (not shown) and the proximal section 222 may include complementary, external threads (not shown), for threading into the branchline outlet 98. In such a configuration, at least a portion of the proximal section 22 may extend into the branchline outlet 98.

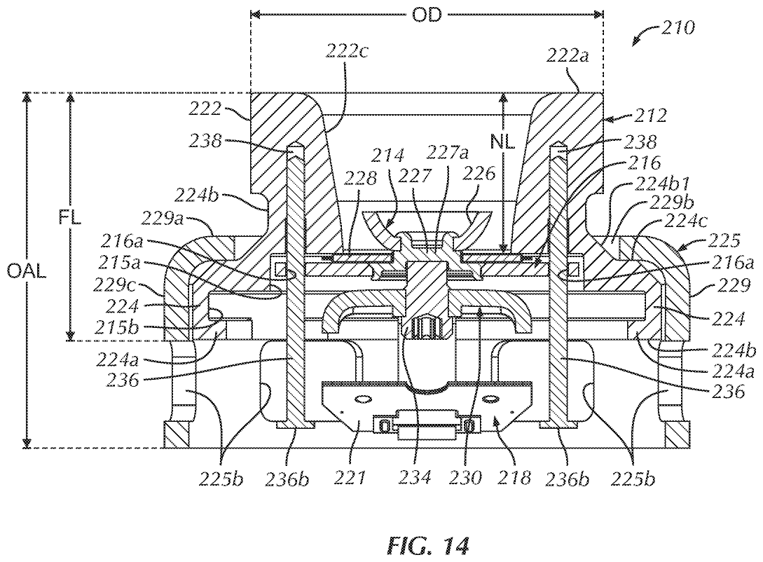

An aspect of certain configurations of the compact sprinkler 210 includes the dimensions of various aspects of the sprinkler, including relative dimensions of certain components. As shown in FIG. 14, the sprinkler 210 defines an overall length OAL from the proximal inlet 222a of the sprinkler frame 212 to the distal-most edge of the crown 225, a frame length FL from the proximal inlet 222a of the sprinkler frame 212 to the distal-most edge 224b of the sprinkler frame 212, an outside diameter OD of the proximal section 222, and a nozzle length NL from the proximal inlet 222a to the distal outlet 222b. In configurations intended to be connected to branchline outlets having a size corresponding to NPS 1 size pipe, the OD may be approximately 1.315″ in diameter (e.g., having a range between approximately 1.1″ in diameter and approximately 1.4″ inches in diameter), in threaded or grooved configurations. In certain configurations, the OAL may be less than 1.75″, and preferably less than 1.5″. In another aspect, the OAL may be approximately equivalent to the OD (e.g., within +/−0.020″ of the OD). The FL may be less than 1.5″ and preferably less than 1.25″. The NL may be less than 0.8″, and preferably about 0.6″. A further aspect of a compact sprinkler according to certain embodiments concerns the operating length OL from the inlet 222a to the proximal edge of the deflector 216, when located in the second position, which may be less than 1.75″, and preferably less than about 1.25″. In another aspect, the OL is less than the maximum diameter of the sprinkler frame FD.

As shown best in FIGS. 10, 12 and 13, the sprinkler frame 212 defines an external peripheral groove/circumferential undercut 224b underlying the proximal section 222. If the coupling 80 is utilized to mount the sprinkler 210 to the branchline outlet 98, the lower lip 80b of the coupling 80 seats into and engages the undercut 224b. Axially underlying the undercut 224b is a radially outwardly beveled surface 224b1 extending therefrom to a proximal end of the distal section 224. Similarly to the sprinklers 10, 110, the distal section 224 defines greater internal and external cross-sectional peripheral dimensions (e.g., diameters) than the internal and external cross-sectional peripheral dimensions (e.g., diameters) of the proximal section 222, respectively.

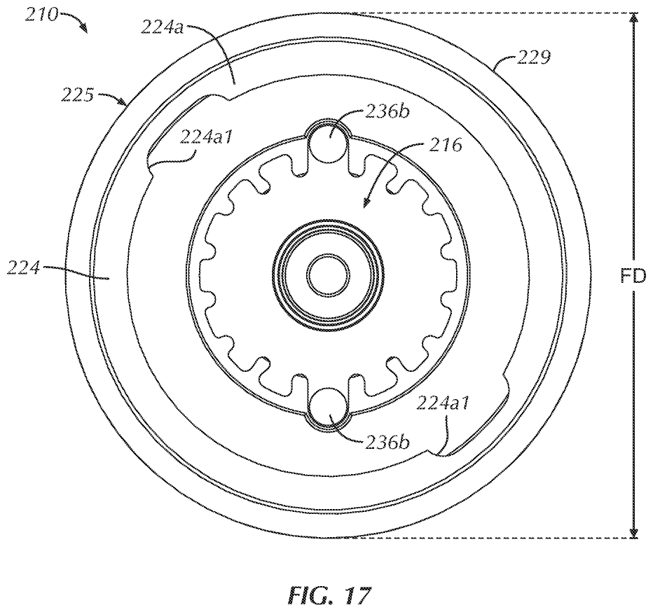

Internally, the proximal section (or inlet portion) 222 is nozzle-shaped in a proximal-to-distal direction, i.e., the internal fire suppression fluid passageway 222c is generally convergent in the proximal-to-distal direction, terminating in the distal outlet 222b in the form of an orifice. In the present configuration, the passageway 222c is convergent all the way to the distal outlet 222b. The sprinkler frame 212 defines a first terraced cavity 215a, distally adjacent to, i.e., distally in series with, the orifice 222b. As shown best in FIGS. 14-16, the first terraced cavity 215a defines a greater lateral cross-sectional dimension, e.g., diameter, than the orifice 222b. Distally adjacent to the first terraced cavity 215a is a second terraced cavity 215b. The second terraced cavity 215b defines a greater lateral cross-sectional dimension, e.g., diameter, than the first terraced cavity 215a. A radially inwardly projecting ledge/lip 224a overhangs the second terraced cavity 215b, thereby defining a lateral cross-sectional dimension smaller than that of the second terraced cavity 215b. In the present embodiment, annular seal 228 and the fluid deflector 216 are positioned within the first terraced cavity 215a, and the load bar 230 is positioned within the second terraced cavity 215b, in the non-operative configuration. As shown best in FIG. 17, the lip 224a includes two recesses 224al, e.g., diametrically opposed, sized and dimensioned to permit the load bar 230 to be assembled into the sprinkler frame 212 during manufacture.

Another difference between the sprinkler 210 of the third embodiment and the sprinklers 10 and 110 of the first and second embodiments is that the crown 225 is a separate component from the sprinkler frame 212. In one configuration, the crown 225 may be constructed of a different material than the sprinkler frame 212, but the disclosure is not so limited. As one non-limiting example, the crown 225 may be constructed of a stronger material, e.g., steel, which advantageously increases the strength of the crown 225, and therefore is increasingly effective for protection of the internal operative components of the sprinkler 210, while also decreasing manufacturing cost. Further advantageously, the two-piece construction of the sprinkler frame 212 and the crown 225 simplifies assembly of the sprinkler 210. That is, the internal components, e.g., the seal and splitter assembly 214, the fluid deflector 216, the heat sensor/thermal trigger 218, and the load bar 230, among other internal components, may be assembled first, prior to mounting the crown 225 upon the sprinkler frame 212.

In the illustrated embodiment, the crown 225 takes the form of a collar 229 slidably engageable with the sprinkler frame 212. As shown best in FIG. 14, the distal section 224 defines a generally planar, axially proximal-most surface 224c operating as a shoulder to support the collar 229 thereon. The collar 229 includes a proximal, radially inwardly projecting, laterally extending peripheral ledge 229a, defining an aperture 229b within. The ledge 229a and the aperture 229b are dimensioned to be larger external cross-sectional peripheral dimension of the proximal section 222 and smaller than the external cross-sectional peripheral dimension of the distal section 224. Accordingly, the collar 229 is slidable from the proximal end of the sprinkler frame 212 beyond the proximal section 222 and the ledge 229a is supported upon the proximal-most surface 224c of the distal section 224.

The collar 229 further includes a skirting peripheral sidewall 229c distally extending from the ledge 229a. The sidewall 229c is axially dimensioned to extend beyond the internal components of the sprinkler 210 when the crown 225 is mounted upon the sprinkler frame 212, for protection of the internal components. The sidewall 229c includes a plurality of spaced apart, air-flow windows 225b formed therein about a circumferential periphery of the sidewall 229c. The windows 225b are dimensioned and/or positioned to at least partially elevationally overlap with the fusible link 221, and function in similar manner to the air-flow apertures 25b and 125b of the sprinklers 10 and 110, respectively. Advantageously, the sidewall 229c is circumferentially continuous distal to the windows 225b, thereby providing the crown 225 with increased structural integrity and robustness for protection of the internal components of the sprinkler 210, while still enabling air-flow via the windows 225b.

The size of the air-flow windows 225b may be advantageously selected in order to control the amount of heated air from a fire plume that can access the fusible link 221. One way of defining the size of the air-flow windows 225b and how they affect the amount of heated air that can access the fusible link 221 is by describing the total area of all the air-flow windows 225b about the crown 225 relative to the area of the outer surface of the crown 225 (in the absence of any windows) as measured from the distal edge 224b of the sprinkler frame to the distal-most edge of the crown 225. By increasing the relative area of the air-flow windows 225b, more heated air can access the fusible link 221, decreasing the time until the solder melts and the sprinkler is activated. This effect can be employed to control the RTI characteristic of the sprinkler without altering the fusible link 221. For example, it has been found that where the airflow windows 225b occupy greater than about 65% of the area of the crown 225 (and in particular about 67.5%), an RTI which qualifies as Quick Response can be achieved. A reduction in the area of the air-flow windows 225b is expected to allow an RTI which qualifies as Standard Response to be achieved.

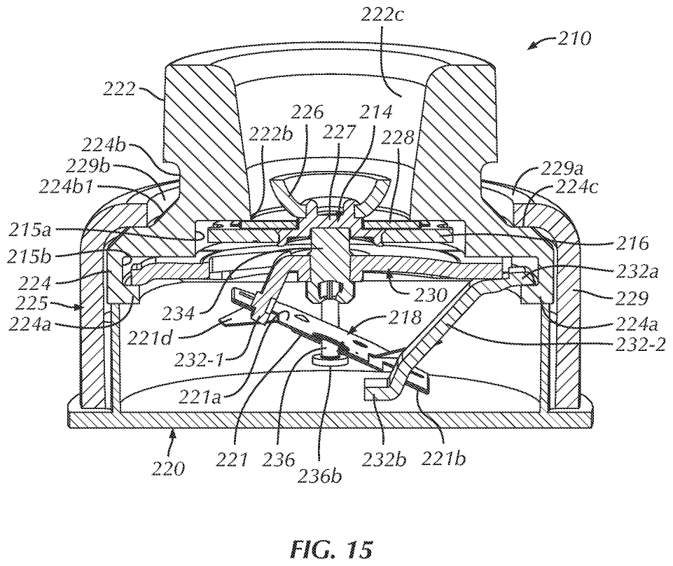

In one configuration, the crown 225 may be mounted upon the sprinkler frame 212 in a rotational manner such that each of the heat collector fins 221d is angularly aligned with at least one of the air-flow windows 225b. Thus, in one configuration, the crown 225 may be rotatably fixed with sprinkler frame 212 when mounted thereon, but the disclosure is not so limited. For example, without limitation, the crown 225 may be keyed to the sprinkler frame 212, spot welded to the sprinkler frame 212, or the like. As shown best between FIGS. 10 and 14, if the coupling 80 is utilized, the crown 225 is axially sandwiched (and stabilized) between the coupling 80, e.g., the distal lip 80b thereof, and the sprinkler frame 212, e.g., the ledge 229a thereof. Additionally, or alternatively, the crown 225 may also be axially fixed to the sprinkler frame 212 via spot welding or other functionally similar mechanisms. As shown in FIG. 15, a protective cap 220 includes a skirting side wall configured (in length and diameter) to engage the distal section 224 of the sprinkler frame 212, e.g., the lip 224a, upon mounting of the protective cap 220 to the sprinkler 210. Alternatively, or additionally, a continuously circumferential skirting side wall may be substituted or supplemented with axially extending members, e.g., legs. Advantageously, during assembly, and particularly when the crown 225 is axially slidable until engagement of the sprinkler frame 212 with the coupling 80, the protective cap 220 may serve as a bearing or push surface to press the sprinkler 210, including the sprinkler frame 212 and the crown 225, into the coupling 80. The protective cap 220 also covers internal components of the sprinkler 210 during assembly and subsequent transit to protect against damage. Thereafter, the protective cap 220 may also serve as a bearing or push surface during installation of the sprinkler 210 and the attached coupling 80 to a branchline outlet 98.

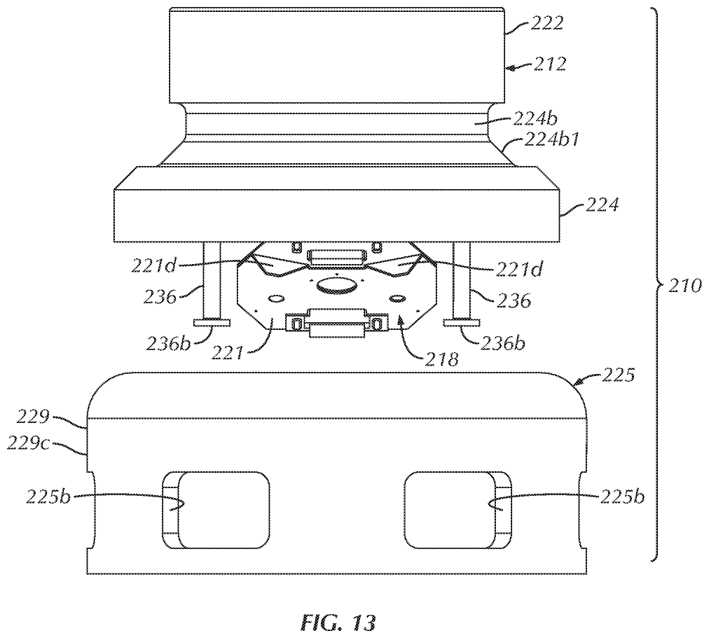

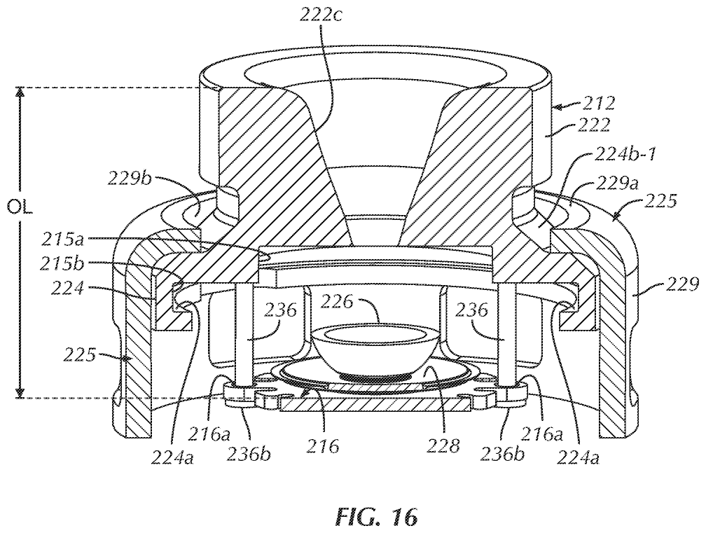

As shown best in FIGS. 14 and 16, another difference between the sprinkler 210 of the third embodiment and the sprinklers 10 and 110 of the first and second embodiments is that the pair of pins 236 are fixedly mounted, i.e., anchored, to the sprinkler frame 212 and the deflector 216 is slidably engaged with the pins 236. That is, the pins 236 are axially immobilized at a proximal end thereof within the sprinkler frame 212 via any mechanism(s) currently known or that later become known, such as, for example, without limitation, welding, latching, swaging or the like, within the channels 238, or other functionally similar mechanisms. As shown best in FIGS. 13 and 14, the pins 236 are arrayed at a diameter less than the external diameter of the proximal section 222, and, in turn, less than an external diameter of the branchline outlet 98. The deflector 216 includes a pair of diametrically opposed through-holes 216a in axial alignment with the pair of pins 236 for receipt of the pins 236 through the through-holes 216a in a slidable manner. The pins distally extend 236 to a sufficient elevational position (beyond the distal section 224 and within the crown 225) for the deflector 216 to slide down to in the operational position of the sprinkler 210, as will be described in further detail below. Each of the pins 236 includes a distal stop surface 236b, e.g., a laterally oriented surface dimensioned greater than the through-holes 216a of the deflector 216, such that the deflector 216 may rest upon, and is elevationally supported by, the stop surfaces 236b of the pins 236 in the operational position of the sprinkler 210 (FIG. 16).

As shown best in FIGS. 11 and 14-16, another difference between the sprinkler 210 of the third embodiment and the sprinklers 10 and 110 of the first and second embodiments is that the splitter 226 is generally bowl-shaped. The bowl shape of the splitter 226 is a generally concave, spherical or non-spherical structure, in a proximal to distal direction. As shown best in FIGS. 14 and 15, the splitter 226 may be attached to the base-body 227 in a similar manner as the deflector 16 of the sprinkler 10, i.e., via mounting onto a proximal end of the central post 227a and swaging.

As should be understood by those of ordinary skill in the art, fire suppression fluid under high pressure flow is turbulent and induces changes in force and pressure on the deflector 216. Stated differently, the fire suppression fluid may unevenly contact different portions of the deflector 216. In the present configuration, wherein the deflector 216 is slidably engaged with the pins 236 rather than being secured to the pins 236, the deflector is more susceptible to vibrate/rattle (i.e., wobble) and/or enlarge the through-holes 216a. Advantageously, when the sprinkler 210 is activated, the high-velocity core of the fire suppression fluid stream exiting the fluid passageway 222c impacts and fills the bowl-shaped splitter 226 with fire suppression fluid. Impacting and filling of the splitter 226 with the fire suppression fluid creates a volume of evenly distributed force (radially and axially) upon the underlying deflector 216, which assists in stabilizing and leveling the deflector 216. Once the splitter 226 is full, the splitter 226 operates substantially as a solid splitter for the remainder of the fire suppression fluid stream. A diameter of the splitter 226 (measured at the widest cross-section thereof) is balanced to be wide enough to adequately stabilize the underlying deflector 216, as well as to laterally disperse the fire suppression fluid beyond the annular seal, e.g., Belleville seal 228, and onto the deflector 216, without occluding the deflector 216. In one non-limiting configuration, the diameter of the splitter 226 (measured at the widest cross-section thereof) may be between approximately 75% and approximately 80% of the diameter of the distal orifice/outlet of the passageway 222c, and between approximately 47.5% and approximately 52.5% of the diameter of the deflector 216.

Turning to FIG. 15, another difference between the sprinkler 210 of the third embodiment and the sprinklers 10 and 110 of the first and second embodiments pertains to the load bar 230 the pair of lever arms 232-1, 232-2 generally positioned between the seal and splitter assembly 214 and the fusible link 221. As shown in FIGS. 14-16, the distal end of the distal section 224 forms the radially inwardly projecting ledge/lip 224a along at least a portion of the inside sidewall thereof. The load bar 230 includes a first lever arm 232-1 projecting distally therefrom (as will be described in further detail below) and into the fusible link 221. In one configuration, the first lever arm 232-1 projects distally beyond the distal extent of the distal section 224 and within the crown 225. The second lever arm 232-2 is positioned with the proximal end 232a thereof axially supported upon the lip 224a. As shown in FIG. 15, one end of the load bar 230 (opposite the second lever arm 232-2) is directly axially supported upon the lip 224a. The opposing end of the load bar 230 is axially supported upon the proximal end 232a of the second lever arm 232-2, trapping/securing the second lever arm 232-2 upon the ledge 224a. In the illustrated configuration, the second lever arm 232-2 also projects distally beyond the distal extent of the distal section 224 and into the fusible link 221 within the crown 225. As previously described with respect to the sprinkler 10, the load bar 230 generates an axial load onto the proximal end 232a of the second arcuate lever arm 232-2, which creates a radially outwardly directed torque upon each the distal end 232b of the arcuate second lever arms 232-1, thereby resulting in a tensile force on the fusible link 221 relative point of fusible link 221 engagement with the first lever arm 232-1, which contributes to elevationally stabilizing the fusible link 221.

As shown, the first lever arm 232-1 is integrated into the load bar 230. In one configuration, the first lever arm 232-1 may be monolithic with, and formed out of, the load bar 230, which advantageously reduces overall components, and, therefore, manufacturing costs. Conversely, the first lever arm 232-1 may be affixed to the load bar 230, e.g., welded thereto. The first lever arm 232-1 is shorter than the second lever arm 232-2. Accordingly, the fusible link 221, engaged proximate one end with the first lever arm 232-1 and engaged proximate an opposing end with the second lever arm 232-2 is inclined relative to the axial axis, i.e., not perpendicularly oriented relative to the axial axis. Advantageously, the angularly oriented fusible link 221, which at least partially axially overlaps with the windows 225b of the crown 225, may be better positioned in the path of heat flow, flowing through the windows 225b, thereby resulting in more efficient activation thereof. The thermal trigger 218, e.g., fusible link 221, remains positioned entirely within the crown 225, i.e., the distal end thereof does not axially extend beyond the distal end of the collar 229, in the non-operative configuration of the sprinkler 210.

In operation, the sprinkler 210 is maintained in the non-operative configuration (e.g., FIGS. 14, 15) in the absence of a fire/thermal event. Though protected by the crown 225, the air-flow windows 225b maintain adequate airflow to the thermal trigger 218. In the instance of a fire/thermal event, and upon activation of the thermal trigger 218, e.g. when the solder between the two metal plates 221a, 221b of the fusible link 221 reaches the designated temperature at which the solder melts and the two metal plates 221a, 221b detach from one other and fall away, the previously described (with respect to the sprinkler 10) force equilibrium maintaining the Belleville seal 228 in sealing engagement with the distal outlet of the passageway 222c is disrupted. The load bar 230, the second lever arm 232-1, and the load screw 234, therefore, also fall away. The Belleville seal 228 is, thus, overcome by the upstream pressurized fire suppression fluid from within the fluid passageway 222c, thereby sliding the seal and splitter assembly 214 and the deflector 216 axially distally along the pins 236, into the operational position of the sprinkler 210 (FIG. 16). The stop surfaces 236b of the pins 236 stabilize the seal and splitter assembly 214 and the attached deflector 216 in the operational position thereof. In the illustrated embodiment, the seal and splitter assembly 214 and the attached deflector 216 remain within the axial extent of the crown 225, and, therefore, remains protected thereby during operation, but the disclosure is not so limited. The fire suppression fluid sprays out from the passageway 222c into the splitter 226 (as previously described) as well as impacting the deflector 216 for distribution thereof in a desired spray pattern according to the design of the deflector 16 (e.g., FIG. 17), e.g., directed into the respective storage rack 97.

In one configuration, as shown best in FIG. 17, the deflector 216 may define a generally circular or arcuate peripheral extent. In one configuration, the peripheral extent of the deflector 216 may define a plurality of cutouts. As previously described, the deflector 216 may include a generally central aperture 216b for mounting to the base body 227. The deflector 216 may further include a pair of oppositely oriented wing portions 216c, mirrored about the central aperture 216b, the wing portions 216c. Each wing portion 216c defines one of the through-holes 216a therethrough for slidable receipt of the pins 236. As shown best in FIGS. 14 and 15, the entirety of the deflector 216 is nested within the sprinkler frame 212 in the non-operative configuration/retracted position.

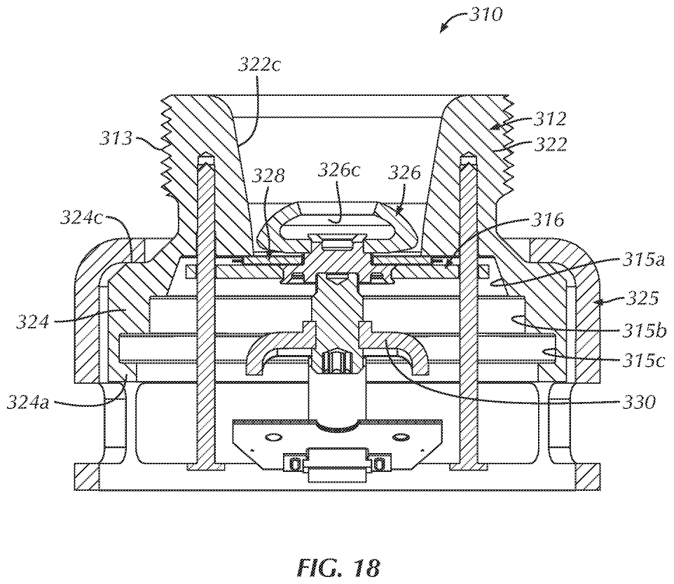

FIG. 18 illustrates a compact sprinkler 310, according to a fourth embodiment of the present disclosure. The reference numerals of the second embodiment are generally distinguishable from those of the previous embodiments (FIGS. 1-17) by a factor of one hundred (100), but otherwise indicate the same elements as indicated above, except as otherwise specified. The compact sprinkler 310 of the present embodiment is similar to that of the previous embodiments and may likewise be employed in an in-rack sprinkler system. Therefore, the description of the sprinkler 310 will generally focus on the differences from the previous embodiments and certain similarities and modes of operation between the embodiments may be omitted herein for the sake of brevity and convenience, and, therefore, is not limiting.

A primary difference between the sprinkler 310 of the present embodiment and the sprinklers 10, 110, 210 of the previous embodiments pertains to the shape of the splitter 326. As shown, the splitter 326 is generally widest at a base end thereof, i.e., the end closest to the annular seal, e.g., Belleville seal 328, and deflector 316, and generally narrowest at an opposing end thereof. Stated differently, the peripheral extent of the splitter 326 radially expands in a proximal to distal direction. Generally the splitter 326 defines a generally arcuate external surface. In one configuration, the splitter 326 defines a generally frustoconical shape with an underlying generally saucer-shaped base, but the disclosure is not so limited. The splitter 326 maintains the confined, interior cavity 326c within, and the access aperture at the proximal end thereof, such that when the sprinkler 310 is activated, the high-velocity core of the fire suppression fluid stream exiting the fluid passageway 322c impacts and fills the splitter 326 with fire suppression fluid to create a volume of evenly distributed force (radially and axially) upon the underlying deflector 316. The radially expanding peripheral extent of the splitter 326 also aids in distribution of the fire suppression fluid traveling from the internal fire suppression fluid passageway 322c by adjusting the angle thereof toward the fluid deflector 316. As shown in FIG. 18, the profile of the interior cavity 326c generally follows the external profile of the splitter 326. The angled orientation of the exterior surface of the splitter 326 also aids in increasing the velocity of the fire suppression fluid.

Internally, the sprinkler frame 312 includes first and second terraced cavities 315a, 315b, as in the embodiment of FIGS. 10-17, but also includes a third terraced cavity 315c, distally adjacent, i.e., distally in series with, the second terraced cavity 315b. The third terraced cavity 315c defines a greater lateral cross-sectional dimension, e.g., diameter, than the second terraced cavity 315b. The radially inwardly projecting ledge/lip 324a overhangs the third terraced cavity 315c, thereby defining a lateral cross-sectional dimension smaller than that of the third terraced cavity 315c. In the present embodiment, annular seal 328 is positioned within the first terraced cavity 315a in the non-operative configuration. The fluid deflector 316 may be positioned within at least one of the first terraced cavity 315a and the second terraced cavity 315b, and the load bar 330 is positioned within the third terraced cavity 315c, in the non-operative configuration.

Optionally, as shown in FIG. 18, the proximal section 322 of the sprinkler frame 312 may be externally threaded and the branchline outlet 98 may be internally threaded (not shown), whereby the sprinkler 310 is threadedly engaged with the branchline outlet 98. In such a configuration, at least the proximal section 222 of the sprinkler frame 312 is concealed within the branchline outlet 98. In one configuration, the crown 325 may be at least one of axially or rotatably fixed to the sprinkler frame 312. For example, without limitation, the crown 325 may be pinched between the external threads 313 and the axially proximal-most surface 324c of the distal section 324. Additionally, or alternatively, the crown 325 may be threaded, crimped, welded, or otherwise affixed to the sprinkler frame 312.

Preferred embodiments of the compact sprinkler 10, 110, 210, 310 may have the proximal inlet, the distal outlet, and the internal fire suppression fluid passageway extending therebetween sized and configured in order to define a nominal K-factor in the range of 5.6 to 25, and more preferably ranging from 8 to 14. Similarly, embodiments may have a thermal trigger having an RTI that qualifies the sprinkler as Standard Response or as Quick Response. Certain embodiments may be qualified under standards promulgated by the listing agencies to provide fire protection in different scenarios. For instance, certain embodiments may be qualified as standard spray sprinklers as known in the art and defined by the listed standards, allowing them to be used in those applications for which standard spray sprinklers are approved, including in-rack storage systems. If required by the listing agencies for use in racks (e.g., as an intermediate sprinkler), embodiments may satisfy additional testing such as the lateral discharge requirements of UL199 or the impingement requirement of FM2000, which are designed to establish that sprinklers used in racks are not prevented from being triggered because they are wetted (i.e., cooled) by nearby triggered (i.e., operating) sprinklers. The crown of the compact sprinkler is expected to aid in meeting these requirements. Further embodiments having a nominal K-Factor of 11.2 or greater may be qualified by fire testing in order to be listed by UL199 and/or FM 2000 as CMDA sprinklers, enabling these embodiments to be employed to provide ceiling-only protection in storage occupancies.

It will, therefore, be appreciated by those skilled in the art that various modifications and alterations could be made to the disclosure above without departing from the broad inventive concepts thereof. Some of these have been discussed above and others will be apparent to those skilled in the art. It is understood, therefore, that this invention is not limited to the particular embodiments disclosed, but it is intended to cover modifications within the spirit and scope of the present disclosure, as set forth in the appended claims.

We claim:

1. A sprinkler, comprising:
an axially extending, generally tubular sprinkler frame having an inlet located at a proximal end, and extending toward a distal end;
a plurality of pins anchored to the sprinkler frame and extending distally;
a fluid deflector oriented in a first position in a non-operative configuration of the sprinkler and distally slidable along the pins into a second position in an operative configuration of the sprinkler; and
a thermal trigger supported by the sprinkler frame in the non-operative configuration of the sprinkler at an axial position distal to the deflector,
wherein, the sprinkler frame is configured to mount to a fire protection piping network.

2. The sprinkler of claim 1, wherein the pins terminate at a proximal end thereof within the sprinkler frame.

3. The sprinkler of claim 1, wherein the sprinkler further comprises a protective crown slidably mounted upon the sprinkler frame and extending distally beyond the distal end of the sprinkler frame.

4. The sprinkler of claim 3, wherein the protective crown includes a plurality of circumferentially spaced apart air-flow openings, and the sprinkler frame comprises an axial axis, and the thermal trigger is a fusible link oriented at an inclined angle to the axial axis and at least partially axially overlaps with the air-flow openings.

5. The sprinkler of claim 3, wherein the fluid deflector remains within an axial extent of the protective crown in both the first and second positions.

6. The sprinkler of claim 1, further comprising a splitter positioned proximally to the fluid deflector, wherein a peripheral extent of the splitter radially expands in a proximal-to-distal direction.

7. The sprinkler of claim 6, wherein the splitter defines an interior cavity with an aperture at a proximal end thereof.

8. The sprinkler claim 1, further comprising a seal and splitter assembly supported within the sprinkler frame, the seal and splitter assembly configured to support the fluid deflector and a Belleville seal overlying the fluid deflector, the seal and splitter assembly including a splitter overlying the Belleville seal, the splitter being configured to stabilize the fluid deflector in the operative configuration.

9. A sprinkler, comprising:
an axially extending, generally tubular sprinkler frame having a proximal section and a distal section;
a fluid deflector oriented in a first position in a non-operative configuration of the sprinkler and distally slidable into a second position in an operative configuration of the sprinkler;
a splitter positioned proximally to the fluid deflector, wherein a peripheral extent of the splitter radially expands in a proximal-to-distal direction; and
a thermal trigger supported by the sprinkler frame in the non-operative configuration of the sprinkler at an axial position distal of the splitter,
wherein the sprinkler frame is configured to mount to a fire protection piping network.

10. The sprinkler of claim 9, wherein the splitter includes a confined, interior cavity with an access aperture at a proximal end thereof.

11. The sprinkler of claim 10, wherein a profile of the interior cavity generally follows an external profile of the splitter.

12. The sprinkler of claim 9, wherein the sprinkler further comprises a protective crown slidably mounted upon the sprinkler frame.

13. A sprinkler, comprising:
an axially extending, generally tubular sprinkler frame having a proximal section and a distal section;
a fluid deflector oriented in a first position in a non-operative configuration of the sprinkler and distally slidable into a second position in an operative configuration of the sprinkler;
a fusible link supported by the sprinkler frame in the non-operative configuration of the sprinkler, the fusible link being oriented in an axially inclined manner,
wherein, the sprinkler frame is configured to mount to a fire protection piping network.

14. The sprinkler of claim 13, further comprising a load bar stabilized within the sprinkler frame in the non-operative configuration of the sprinkler, the load bar being proximally positioned relative to the fusible link;
a first lever arm stabilized by the load bar proximate one end and engaged with the fusible link proximate an opposing end, in the non-operative configuration of the sprinkler; and
a second lever arm stabilized by the load bar proximate one end and engaged with the fusible link proximate an opposing end, in the non-operative configuration of the sprinkler.

15. The sprinkler of claim 14, wherein the second lever arm projects distally further than the first lever arm, thereby orienting the fusible link in the axially inclined manner.

16. The sprinkler of claim 14, wherein the first lever arm is monolithically formed with the load bar and projects distally therefrom.

17. The sprinkler of claim 13, further comprising a splitter positioned proximally to the fluid deflector, wherein a peripheral extent of the splitter radially expands in a proximal-to-distal direction.

18. The sprinkler of claim 13, further comprising a protective crown distally extending beyond the distal section of the sprinkler frame, the protective crown including a plurality of circumferentially spaced apart air-flow openings.

19. The sprinkler of claim 18, wherein the fusible link at least partially axially overlaps with the air-flow openings.

20. The sprinkler of claim 13, further comprising a pair of pins anchored to the sprinkler frame distally extending, the fluid deflector being slidable along the pair of pins.

21. The sprinkler of claim 13, wherein the sprinkler frame comprises a distally extending, convergent nozzle distally terminating in an orifice;
a first terraced cavity, distally adjacent to the orifice, the first terraced cavity having a larger diameter than the orifice;
a second terraced cavity, distally adjacent to the first terraced cavity, the second terraced cavity having a larger diameter than the first terraced cavity;
a third terraced cavity, distally adjacent to the second terraced cavity, the third terraced cavity having a larger diameter than the second terraced cavity; and
a lip overhanging the third terraced cavity, the lip defining a smaller diameter than the third terraced cavity.

22. The sprinkler of claim 21, further comprising a load bar stabilized within the sprinkler frame in the non-operative configuration of the sprinkler, wherein the load bar is located within the third terraced cavity.

23. A sprinkler, comprising:
an axially extending, generally tubular sprinkler frame having a proximal section and a distal section;
a protective crown distally extending beyond the distal section of the sprinkler frame, and having a plurality of circumferentially spaced apart air-flow openings;
a fluid deflector oriented in a first position in a non-operative configuration of the sprinkler and distally slidable into a second position in an operative configuration of the sprinkler, the fluid deflector being positioned within an axial extent of the protective crown in the first position; and
a fusible link supported by the sprinkler frame in the non-operative configuration of the sprinkler at an axial position within the axial extent of the protective crown, and wherein the fusible link at least partially axially overlaps with the air-flow openings,
wherein, the sprinkler frame is configured to mount to a fire protection piping network.

24. The sprinkler of claim 23, wherein the protective crown distally extends a same axial extent, or axially beyond, a distal extent any other component of the sprinkler.

25. The sprinkler of claim 23, wherein the protective crown defines a circumference and a series of air-flow windows about the circumference, the air-flow windows being sized and configured such that the sprinkler qualifies as a quick response sprinkler.

26. The sprinkler of claim 23, wherein the fluid deflector is positioned within the axial extent of the protective crown in the second position.

27. The sprinkler of claim 23, wherein the fluid deflector is positioned beyond the axial extent of the protective crown in the second position.

28. The sprinkler of claim 23, wherein the proximal section of the sprinkler frame defines a proximal inlet, a distal outlet and an internal fire suppression fluid passageway extending therebetween, and wherein a splitter is positioned within the internal fire suppression fluid passageway in the non-operative configuration.

29. The sprinkler of claim 28, wherein a peripheral extent of the splitter radially expands in a proximal-to-distal direction.

30. The sprinkler of claim 23, further comprising a seal and splitter assembly supported within the sprinkler frame, the seal and splitter assembly configured to support the fluid deflector and a Belleville seal, the Belleville seal overlying the fluid deflector, the seal and splitter assembly including a splitter overlying the Belleville seal, the splitter being configured to adjust the angle of fire suppression fluid traveling from an internal fire suppression fluid passageway toward the fluid deflector.
